(19) United States
(12) Patent Application Publication
(10) Pub. No.: US 2014/0047846 A1
(43) Pub. Date: Feb. 20, 2014

(54) TURBINE COMPONENT COOLING ARRANGEMENT AND METHOD OF COOLING A TURBINE COMPONENT

(71) Applicants: Christopher Paul Willis, Liberty, SC (US); Richard Martin DiCintio, Simpsonville, SC (US); William David York, Greer, SC (US)

(72) Inventors: Christopher Paul Willis, Liberty, SC (US); Richard Martin DiCintio, Simpsonville, SC (US); William David York, Greer, SC (US)

(73) Assignee: GENERAL ELECTRIC COMPANY, Schenectady, NY (US)

(21) Appl. No.: 13/585,568

(22) Filed: Aug. 14, 2012

(51) Int. Cl. F02C 7/12; F23R 3/02; F23R 3/26

(52) U.S. Cl. 60/772; 60/752; 60/754

(57) ABSTRACT

A turbine component cooling arrangement includes a combustor liner defining a combustor chamber, wherein the combustor liner includes an outer surface and an inner surface. Also included is a channel disposed along the outer surface, wherein the channel is configured to receive a cooling flow through at least one aperture extending through a liner ring disposed proximate the outer surface of the combustor liner. Further included is at least one outlet orifice extending between the channel and the combustor chamber through the inner surface for routing the cooling flow along the inner surface within the combustor chamber.

### BACKGROUND OF THE INVENTION

The subject matter disclosed herein relates to gas turbine systems, and more particularly to a turbine component cooling arrangement, as well as a method for cooling a turbine component.

A combustor section of a gas turbine system typically includes a combustor chamber disposed relatively adjacent a transition piece, where a hot gas passes from the combustor chamber through the transition piece to a turbine section. As gas turbine firing temperatures increase and NOx allowances are reduced, meeting combustor liner life requirements becomes increasingly challenging with currently employed cooling schemes.

One region of the combustor liner requiring effective cooling includes an aft end of the combustor liner, with one common cooling method including channel cooling. Channel cooling typically includes providing a cooling flow to a channel, then subsequently expelling the cooling flow to a region of the transition piece. Unfortunately, the useful length of the channel cooling is dependent on the temperature of the air in the cooling channel, thereby often rendering ineffective cooling of significant portions of the combustor liner due to increased firing temperatures and increased compressor discharge air temperatures. Alternatively, film cooling may be employed at various locations in the combustor chamber. Film cooling typically includes providing air from a plenum between a flow sleeve and the combustor liner to provide a barrier between the hot gas and the combustor liner. Unfortunately, the benefit of the film cooling lasts for a finite length and is highly dependent on the flow characteristics in the film cooled region and only moderately dependent on the temperature of the coolant gas.

### BRIEF DESCRIPTION OF THE INVENTION

According to one aspect of the invention, a turbine component cooling arrangement includes a combustor liner defining a combustor chamber, wherein the combustor liner includes an outer surface and an inner surface. Also included is a channel disposed along the outer surface, wherein the channel is configured to receive a cooling flow through at least one aperture extending through a liner ring disposed proximate the outer surface of the combustor liner. Further included is at least one outlet orifice extending between the channel and the combustor chamber through the inner surface for routing the cooling flow along the inner surface within the combustor chamber.

According to another aspect of the invention, a gas turbine combustion system includes a combustor liner defining a combustor chamber, wherein the combustor liner includes an inner liner portion and an outer liner ring disposed radially outwardly of the inner liner portion. Also included is a channel disposed between the inner liner portion and the outer liner ring and is axially aligned relatively axially therein for receiving a cooling flow through at least one aperture extending through the outer liner ring, wherein the cooling flow is directed throughout the channel along an outer surface of the inner liner portion. Further included is at least one outlet orifice extending from the channel to the combustor chamber through the inner liner portion for flowing the cooling flow along an inner surface of the inner liner portion for cooling therealong.

According to yet another aspect of the invention, a method of cooling a turbine system component is provided. The method includes providing a cooling flow along an outer liner ring. Also included is routing the cooling flow through at least one aperture disposed within the outer liner ring to a channel disposed between the outer liner ring and an inner liner portion for cooling of the inner liner portion. Further included is routing the cooling flow out of the channel through at least one outlet orifice to an inner surface of the inner liner portion for cooling along the inner surface.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a partial schematic illustration of a combustor section of a gas turbine system;

FIG. 2 is an enlarged cross-sectional view illustrating a turbine component cooling arrangement according to a first embodiment;

FIG. 3 is an enlarged cross sectional view illustrating a turbine component cooling arrangement according to a second embodiment; and

FIG. 4 is a flow diagram illustrating a method of cooling a turbine system component.

The detailed description explains embodiments of the invention, together with advantages and features, by way of example with reference to the drawings.

### DETAILED DESCRIPTION OF THE INVENTION

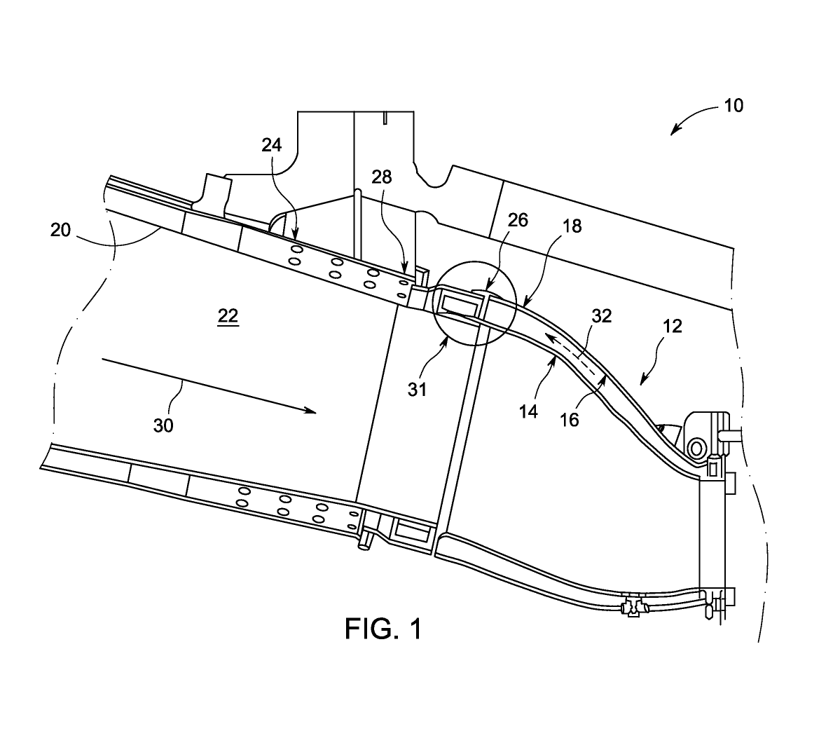

Referring to FIG. 1, a partial schematic illustrates a combustor section of a gas turbine system and is referred to generally with numeral 10. The combustor section 10 includes a transition piece 12 having a transition duct 14 at least partially surrounded by an impingement sleeve 16 disposed radially outwardly of the transition duct 14. Upstream thereof, proximate a forward portion 18 of the impingement sleeve 16 is a combustor liner 20 defining a combustor chamber 22. The combustor liner 20 is at least partially surrounded by a flow sleeve 24 disposed radially outwardly of the combustor liner 20. A forward sleeve 26 is located at the junction between the forward portion 18 of the impingement sleeve 16 and an aft portion 28 of the flow sleeve 24.

The combustor section 10 uses a combustible liquid and/or gas fuel, such as a natural gas or a hydrogen rich synthetic gas, to run the gas turbine system. The combustor chamber 22 is configured to receive and/or provide an air-fuel mixture, thereby causing a combustion that creates a hot pressurized exhaust gas flowing as a hot gas path 30. The combustor chamber 22 directs the hot pressurized gas through the transition piece 12 into the turbine section (not illustrated), causing rotation of the turbine section. The presence of the hot pressurized exhaust gas increases the temperature of the combustor liner 20 surrounding the combustor chamber 22, particularly proximate an aft end 31 of the combustor liner 20. To overcome issues associated with excessive thermal exposure to the combustor liner 20, a cooling flow 32 flows from downstream to upstream along the combustor liner 20 in a relatively opposite direction to that of the hot gas path 30. Specifically, the cooling flow 32 flows from a region defined by the impingement sleeve 16 and the transition duct 14 toward a region defined by the flow sleeve 24 and the combustor liner 20.

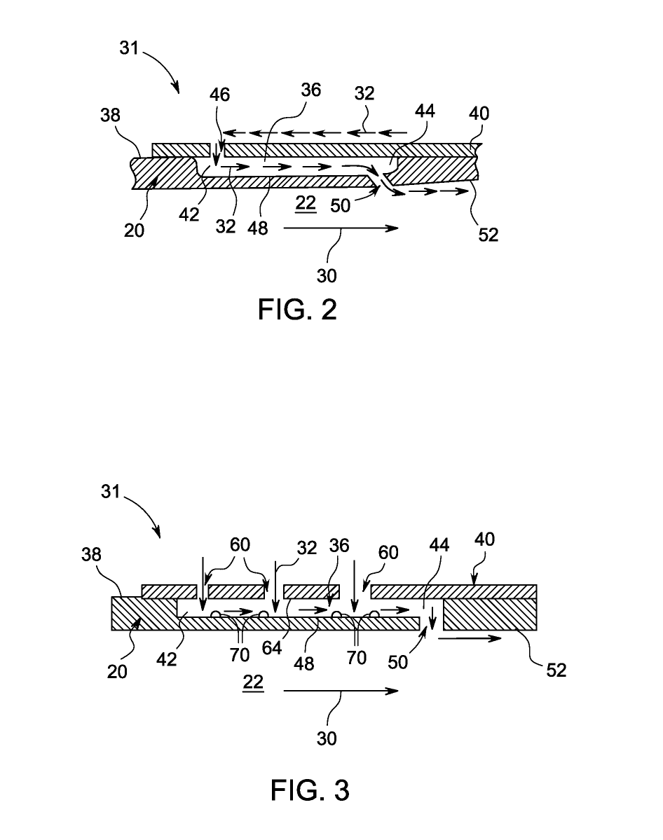

Referring to FIG. 2, an enlarged cross-sectional view of the aft end 31 according to a first embodiment of the combustor liner 20 is shown in greater detail. At least one portion of the aft end 31 includes a channel 36 disposed proximate an outer surface 38 of the combustor liner 20. Disposed relatively adjacent to, and radially outwardly of, the outer surface 38 of the combustor liner 20 and therefore the channel 36, is an outer liner ring 40. The channel 36 extends in a relatively axial direction along the combustor liner 20 and comprises a length L. The channel 36 also includes a forward region 42 and an aft region 44 that define the length L. It is to be appreciated that the channel 36 may be in the form of various dimensions and will be based on numerous parameters of the application employed in conjunction with. For example, the length L, the circumferential dimensional distance and the depth of the channel 36 may all vary. Irrespective of the precise dimensions, the channel 36 is configured to receive the cooling flow 32 through an aperture 46 disposed in the outer liner ring 40. The aperture 46 extends through the outer liner ring 40 and it is to be understood that the aperture 46 may be aligned relatively perpendicularly to the cooling flow 32 or at an angle thereto.

Although it is contemplated that the aperture 46 may be disposed at numerous locations along the length L of the channel 36, typically the aperture 46 is located proximate the forward region 42 of the channel 36. At least a portion of the cooling flow 32 is routed into the aperture 46 and flows throughout the channel 36 along a channel surface 48 for convective cooling of the combustor liner 20. An outlet orifice 50 extends through the combustor liner 20 from the channel 36 to an inner surface 52 of the combustor liner 20, with the inner surface 52 being exposed to the hot gas path 30 within the combustor chamber 22. The outlet orifice 50 provides an exit for the cooling flow 32 flowing within the channel 36 and such a flow tendency is achieved based on the combustor chamber 22 being at a lower pressure than the channel 36, as well as the region defined by the outer liner ring 40 and the forward sleeve 26. As is the case with the aperture 46 described above, it is also contemplated that the outlet orifice 50 may be located at various axial locations along the length L of the channel 36, however, typically the outlet orifice 50 is disposed proximate the aft region 44 of the channel 36. The outlet orifice 50 comprises either a relatively constant circular cross-section or a cross-section that varies over its length from inlet at the channel surface 48 to outlet at the inner surface 52 of the combustor liner 20. Additionally, it is to be appreciated that the outlet orifice 50 may be aligned at numerous angles, including perpendicularly to the direction of flow of the cooling flow 32 and the hot gas path 30, with such angles discussed in more detail below.

Although the combustor section 10 is illustrated and described above as having a single aperture and a single outlet orifice, it is to be appreciated that a plurality of either or both of the aperture 46 and/or the outlet orifice 50 may be included. Specifically, for embodiments having a plurality of apertures and/or outlet orifices, such features may be present at any location along the length L of the channel 36, however, as with the case of the embodiments described above, the apertures and/or outlet orifices are typically disposed proximate the forward region 42 and the aft region 44, respectively. Such an embodiment includes circumferentially spaced apertures and/or outlet orifices, with the spacing between such features ranging depending on the application of use.

With respect to each of the outlet orifices 50, it is contemplated that a plurality of low-angle, round holes may be circumferentially spaced and arranged in a relatively single axial plane. Alternatively, multiple rows may be included to provide axially staggered outlet orifices. As noted above, the outlet orifices 50 may be aligned at various angles, with respect to a surface tangent of the combustor liner 20. For example, the outlet orifice 50 may be aligned at an angle of about 15 degrees to about 90 degrees. In addition to the above-described single angle configuration, it is contemplated that a secondary, or compound, angle may be present to form a first angled portion and a second angled portion of the outlet orifice 50. In such an embodiment, the secondary, or compound, angle may be aligned at about 0 degrees to about 50 degrees, with respect to the axial direction of the first angled portion.

Referring now to FIG. 3, an enlarged cross-sectional view of the aft end 31 according to a second embodiment of the combustor liner 20 is shown in greater detail. The second embodiment of the combustor liner 20 is similar in many respects to that of the first embodiment, however, a plurality of axially spaced apertures 60 are disposed throughout the outer liner ring 40. The plurality of axially spaced apertures 60 provide impingement of the cooling flow 32 into the channel 36, and more specifically onto the channel surface 48 of the combustor liner 20 for cooling thereon. Similar to the first embodiment, the outlet orifice 50 is disposed proximate the aft region 44 of the channel 36 for drawing the cooling flow 32 out of the channel 36, thereby providing an efficient convective channel cooling effect on the combustor liner 20. As is the case with the first embodiment, subsequent to exiting the channel 36 through the outlet orifice 50, the cooling flow 32 is then routed along a portion of the inner surface 52 of the combustor liner 20, thereby providing a film cooling barrier between the hot gas path 30 and the inner surface 52 along a portion downstream of the outlet orifice 50. As described in conjunction with the first embodiment, the second embodiment may include circumferentially spaced apertures for providing impingement of the cooling flow 32.

For each of the embodiments described above, the cooling surface 48 and/or an inner surface 64 of the outer liner ring 40 may include one or more flow manipulating components 70 to impart a desired effect on the flow characteristics of the cooling flow 32 when routing through the channel 36. Illustrative, but not exhaustive, examples of the one or more flow manipulating components 70 include a dimple, a turbulator rib and a chevron. The one or more flow manipulating components 70 may be disposed at any location within the channel 36 to enhance the cooling of the combustor liner 20.

In operation, for both the first embodiment and the second embodiment, the cooling flow 32 is drawn into the channel 36 due to a pressure differential between the combustor chamber 22 and the region proximate the outer liner ring 40. Cooling within the channel 36 is efficient for a predetermined distance that is relatively equal to or less than the length L of the channel 36. At the predetermined distance, which will vary based on numerous parameters associated with the specific application, disposal of the outlet orifice 50 allows the cooling flow 32 to exit the channel 36 to initiate film cooling of a region of the combustor liner 20 within the hot gas path 30.

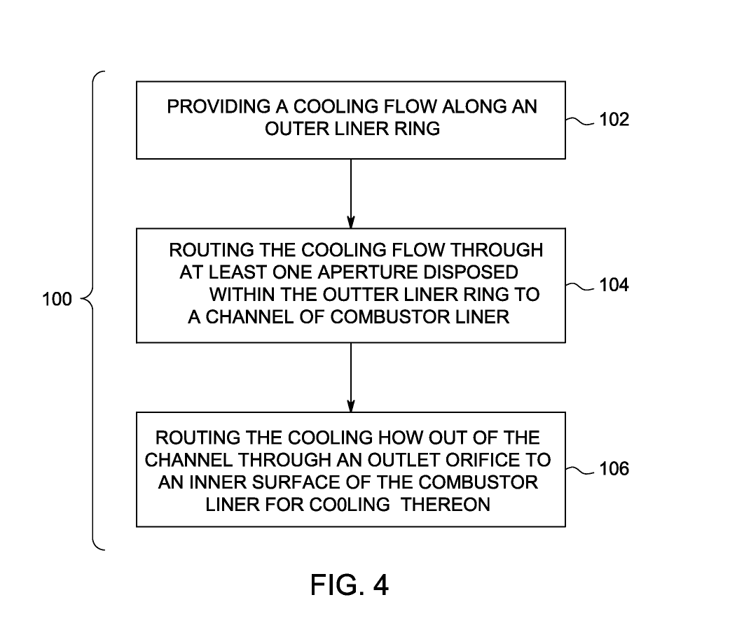

As illustrated in the flow diagram of FIG. 4, and with reference to FIGS. 1-3, a method of cooling a turbine system component 100 is also provided. The combustor section 10, and more specifically the combustor liner 20 have been previously described and specific structural components need not be described in further detail. The method of cooling a turbine system component 100 includes providing a cooling flow along an outer liner ring 102. The cooling flow 32 is then routed to a channel 104 through the aperture 46 described in detail above. Subsequent to cooling the combustor liner 20 by flowing within the channel 36, the cooling flow 32 is routed out of the channel through an outlet orifice 106 to the inner surface 52 of the combustor liner 20 for film cooling therein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbine component cooling arrangement comprising:
a combustor liner defining a combustor chamber, wherein the combustor liner includes an outer surface and an inner surface;
a channel disposed along the outer surface, wherein the channel is configured to receive a cooling flow through at least one aperture extending through a liner ring disposed proximate the outer surface of the combustor liner; and
at least one outlet orifice extending between the channel and the combustor chamber through the inner surface for routing the cooling flow along the inner surface within the combustor chamber.

2. The turbine component cooling arrangement of claim 1, wherein the channel is disposed proximate an aft end of the combustor liner.

3. The turbine component cooling arrangement of claim 1, wherein the channel is relatively axially aligned and comprises a forward region and an aft region.

4. The turbine component cooling arrangement of claim 3, wherein the at least one aperture is disposed proximate the forward region of the channel.

5. The turbine component cooling arrangement of claim 3, wherein the at least one outlet orifice is disposed proximate the aft region of the channel.

6. The turbine component cooling arrangement of claim 1, further comprising a plurality of apertures extending through the liner ring for impinging the cooling flow into the channel and onto a channel surface.

7. The turbine component cooling arrangement of claim 1, wherein the cooling flow is routed to the at least one aperture from an annulus defined by a transition piece liner and an impingement sleeve.

8. The turbine component cooling arrangement of claim 1, further comprising at least one cooling flow manipulator.

9. The turbine component cooling arrangement of claim 8, wherein the at least one cooling flow manipulator comprises at least one of a dimple, a turbulator rib and a chevron.

10. A gas turbine combustion system comprising:
a combustor liner defining a combustor chamber, wherein the combustor liner includes an inner liner portion and an outer liner ring disposed radially outwardly of the inner liner portion;
a channel disposed between the inner liner portion and the outer liner ring and is aligned relatively axially therein for receiving a cooling flow through at least one aperture extending through the outer liner ring, wherein the cooling flow is directed throughout the channel along an outer surface of the inner liner portion; and
at least one outlet orifice extending from the channel to the combustor chamber through the inner liner portion for flowing the cooling flow along an inner surface of the inner liner portion for cooling therealong.

11. The gas turbine system of claim 10, wherein the channel is disposed proximate an aft end of the combustor liner.

12. The gas turbine system of claim 10, wherein the channel comprises a forward region and an aft region.

13. The gas turbine system of claim 12, wherein the at least one aperture is disposed proximate the forward region of the channel.

14. The gas turbine system of claim 12, wherein the at least one outlet orifice is disposed proximate the aft region of the channel.

15. The gas turbine system of claim 10, further comprising a plurality of apertures extending through the outer liner ring for impinging the cooling flow into the channel and onto a channel surface.

16. The gas turbine system of claim 10, wherein the cooling flow is routed to the at least one aperture from an annulus defined by a transition piece liner and an impingement sleeve.

17. The gas turbine system of claim 10, further comprising at least one cooling flow manipulator, wherein the at least one cooling flow manipulator comprises at least one of a dimple, a turbulator rib and a chevron.

18. A method of cooling a turbine system component comprising:
providing a cooling flow along an outer liner ring;
routing the cooling flow through at least one aperture disposed within the outer liner ring to a channel disposed between the outer liner ring and an inner liner portion for cooling of the inner liner portion; and
routing the cooling flow out of the channel through at least one outlet orifice to an inner surface of the inner liner portion for cooling along the inner surface.

19. The method of claim 18, further comprising routing the cooling flow through the at least one aperture at a forward region of the channel.

20. The method of claim 18, further comprising routing the cooling flow through a plurality of apertures disposed at a plurality of axial locations along the channel for impinging the cooling flow onto a channel surface.
